(19) United States
(12) Patent Application Publication
(10) Pub. No.: US 2011/0186387 A1
(43) Pub. Date: Aug. 4, 2011

(54) FASTENING DEVICE FOR A GUIDE RAIL OF AN ELEVATOR INSTALLATION

(76) Inventor: Philipp Schwendenmann, Ebikon (CH)

(21) Appl. No.: 13/021,073

(22) Filed: Feb. 4, 2011

(30) Foreign Application Priority Data
Feb. 4, 2010 (EP) 10152589.7

(51) Int. Cl. B66B 7/02

(52) U.S. Cl. 187/408

(57) ABSTRACT

A fastening device for a guide rail of an elevator installation with a elevator shaft with at least one shaft wall, the device comprising at least one mount for fastening the guide rail to the shaft wall, wherein the fastening device comprises a plastically deformable support device, which carries the guide rail, with deformation points.

### CROSS-REFERENCE TO RELATED APPLICATION

This application claims priority to European Patent Application No. 10152589.7, filed Feb. 4, 2010, which is incorporated herein by reference.

### FIELD

The present disclosure relates to an elevator installation, particularly to the design or fastening of guide rails in the installation.

### BACKGROUND

Typically in an elevator installation, at least one elevator cage or at least one car and at least one counterweight are moved in opposite directions in an elevator shaft. The at least one lift cage and the at least one counterweight run along guide rails, are supported by one or more supporting and drive means and are driven by way of a drive pulley of a drive unit.

The guide rails of an elevator installation on the one hand should be of such rigidity and rectilinearity that they ensure smooth running of the elevator cage or counterweight. On the other hand, the guide rails should be designed for acceptance of relatively high vertical forces. These high vertical forces arise due to the intrinsic weight of the guide rails, in the case of corresponding elevator installations by the mass of the drive mounted at the rails as well as by the masses suspended thereat of the elevator cage and the counterweight, by drive forces, and by the braking forces which act on the rail when the safety braking device responds.

Moreover, the guide rails can in the case of a fixed attachment in a elevator shaft of a newly erected building be subjected to vertical compressive forces, because in certain circumstances the building continues to settle. However, even when the building should have definitively settled, thermal expansion—particularly in the case of tall elevator installations—can generate vertical compressive forces which in turn can lead to warping and bulging of the guide rails.

European Patent No. 0 611 724 B1 discloses fastening points for a guide rail at the side walls of the elevator shaft, which are resiliently mounted by spring brackets. Compensation for unevennesses of the shaft wall is thereby provided and a fastening system is created which corresponds with a rigid, but resiliently embedded, support. A solution for optimization of the acceptance of vertical forces in a guide rail is not, however, described.

U.S. Pat. No. 7,000,736, on the other hand, describes a support device for guide rails consisting of a set of sheet-metal sections which can be preassembled. These sheet-metal sections, which are preassembled in the shaft pit of the elevator shaft, give an aligned construction of a triple configuration of guide rails. This guide rail support device is, however, restricted to the alignment or positioning of the guide rails during assembly and does not disclose any measures for acceptance of the vertical forces in a guide rail or the optimization thereof.

### SUMMARY

In some cases, the disclosed technology comprises an arrangement of a defined plastically deformable support device on which the guide rail is supported or carried.

This support device is, for example, arranged in the shaft pit of the elevator shaft and in each instance carries a guide rail of unitary or multi-part construction. The support device can comprise a support plate on which the cross-sectional profile of an upright guide rail is detachably or, however, fixedly mountable. An optional design variant of the support plate provides a recess, also termed seat, in an upper side of the support plate for mechanically positive seating of the cross-sectional profile of the guide rail. The guide rail can be horizontally stabilized in this manner insofar as the support device is fixed on the shaft floor by, for example, screw-connection.

The upper side of the support plate can go over into at least two side flanks of the support device. These side flanks in turn go over into a lower side of the support device, which has at least one base surface.

The support device can be plastically deformable. This can be ensured in that, for example, the entire support device, thus the support plate, the side flanks and the support surfaces, plastically deform. According to an embodiment, however, the side flanks have intended bending points or intended deformation points so that the plastic deformation takes place principally in these side flanks. The support plate and the base surfaces can be designed so that they do not deform, not even when the intended deformation points have reached their maximum degree of deformation.

Plastic deformation as far as a defined degree of deformation is achieved, in an exemplifying embodiment, by support pieces which are introducible in a specific number into the support device. In this manner a spacing is settable, for example between the uppermost support piece and the lower side of the support plate, which allows a plastic deformation of the support device only within a defined range. In principle, an abutment limiting the plastic deformation travel of the support device is also possible instead of the support pieces.

Through the described defined deformation it can thus be possible to limit vertical forces which, in the guide rail, exceed the magnitude of a load which usually arises. Vertical forces caused, for example, by the intrinsic weight of the guide rail, by instances of braking or by a drive at the rail side can be borne by the support device with only a small elastic deformation. Vertical loads such as, however, arise due to subsidence of the building (a deformation load) lead to a plastic deformation of the support device, whereby the rail longitudinal force can be limited. Undesired warping, stresses at the points of fastening of the guide rail to the shaft walls or bulging of the guide rail can thus be avoided.

The lower side of the support plate or cover surface on which the support plate rests and/or one of the support pieces or the travel-limiting abutment can optionally have a pressure sensor or merely a limit switch, which provides information about whether the defined degree of deformation of the support device has been reached. Insofar as the limitation of the plastic deformation takes place by support pieces—possibly within the range of possible plastic deformation of the support device—there is thus a possibility of adaptation of the support device in the manner that in the case of a corresponding signal of the pressure sensor or sensors a support piece can be removed and thus a further range of deformation can be available.

A support device can be usable a plurality of times. It can consist of a material which still does not break even after a number of plastic deformations, but can be subsequently straightened on a straightening bed or a press and can thus be suitable for re-mounting in a elevator installation.

As already mentioned, a support device can have at least two side flanks each with a respective intended deformation point or with a respective plurality of intended deformation points. A possible design variant of a support device is C-shaped in cross-section and stands by the opening of the C on the shaft floor. The intended deformation points can be realized in that the material, for example thick sheet metal, is thinned at the side flanks of the support device.

A further design variant of a support device thereagainst can provide for the side flanks to be separated and possibly formed as respective housing parts both at the bottom and the top, into which a block-shaped bar of a material different from the support device is insertable. This material or the block-shaped bar of this material can have a previously investigated strength and a defined deformation behavior. Longitudinal forces which arise in the guide rail and exceed the usual magnitude can thus deform merely the definedly deformable bars, the maximum deformation of which can be made visible by differently colored side markings in a gap still present between the two housing halves. A simple visual check thus gives information about whether in certain circumstances a new deformable bar has to be inserted.

A fastening device can also comprise, apart from the stated support device, mounts for fastening the guide rail to the shaft wall. According to an optional variant of embodiment these mounts can allow a guided vertical displacing movement of the guide rail. This can in principle be realized by a screw connection guided in a slot or by a retaining guide engaging around a guide profile or also by rollers. However, a fastening device can also be realized by fixed mounts, as well as by mounts which are indeed fixed, but yield in the case of a load of appropriately high level. Use can also be made of mounts which are favorable in cost and which embrace the profile of the guide rail by means of two jaws and are closed by at least one screw connection. The screw connection can be tightened by a specific torque so that only from the occurrence of a correspondingly high level of vertical force in the guide rail does a displacement of the guide rail in the mounts arise.

Moreover, a fastening device can be suitable not only for elevator installations with an engine room, but also for elevator installations without an engine room, particularly, however, for the latter, in which the vertical loading of the guide rails is higher due to the mass forces of the elevator installation which are derived from the drive, which is fastened to the guide rails, on the shaft floor.

The described individual features can be combined with one another to form a fastening device or a elevator installation; thus by way of example the described different embodiments of the support device—with or without support pieces or with or without a pressure sensor—can be combined with the disclosed mounts regardless of the form of the intended deformation point.

At least some embodiments of an elevator installation disclosed herein can bring the following results:
Excessive vertical loads of the guide rail do not have the consequence of excessive stresses, warping or bulging of the guide rail.
Compensation can be provided for subsequent subsidence of the building or thermal expansion movements.
The elevator cage and the counterweight are guided securely and smoothly at the guide rails.
An elevator installation with at least one fastening device as well as mounts offers cost advantages, particularly with respect to a reduced need for inspection and maintenance.
Use can be made of a guide rail profile of lower stiffness. This can lead to advantages in material and costs.

### BRIEF DESCRIPTION OF THE DRAWINGS

The disclosure is explained in more detail symbolically and by way of example on the basis of figures. The figures are described conjunctively and generally. The same reference numerals signify the same components and reference numerals with different indices indicate functionally identical or similar components.

FIG. 1 shows a schematic illustration of an exemplifying elevator installation with guide rails, which are supported and fastened in accordance with the prior art;

FIG. 2 shows a schematic illustration of a first variant of embodiment of a fastening device with a support device and mounts;

FIG. 3 shows a schematic illustration of a second variant of embodiment of a fastening device with a further support device and further mounts; and

FIG. 4 shows a plot of the deformation of the support device.

### DETAILED DESCRIPTION

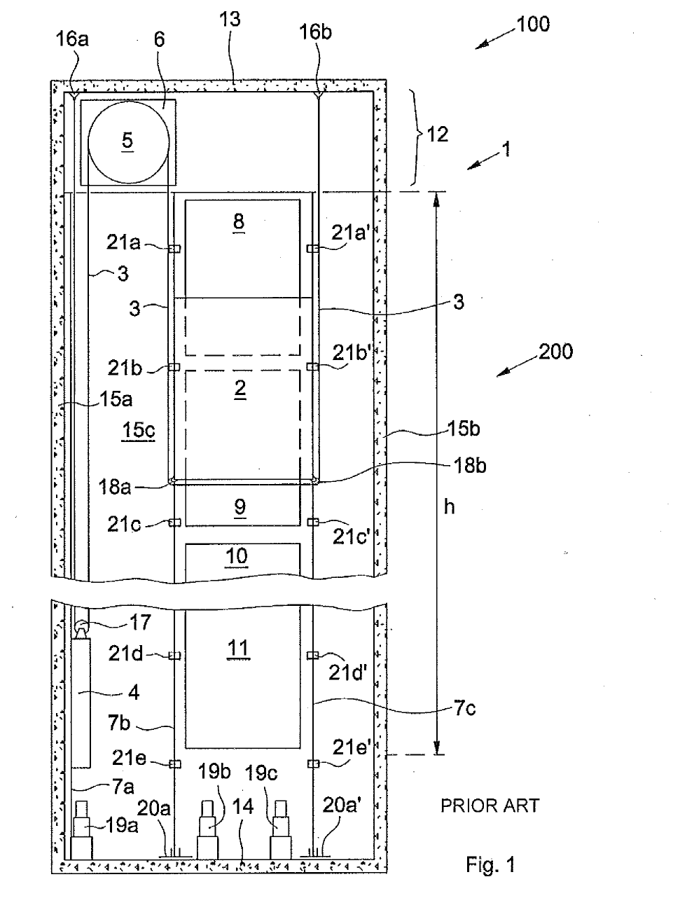

FIG. 1 shows an elevator installation 100 such as is known from the prior art, with, by way of example, a 2:1 cable guidance. An elevator cage 2, which is connected by way of a supporting and drive means 3 with a movable counterweight 4, is arranged in an elevator shaft 1 to be movable. The supporting and drive means 3 is, in operation, driven by means of a drive pulley 5 of a drive unit 6, these being arranged in the uppermost region of the elevator shaft 1 or in an engine room 12. The elevator cage 2 and the counterweight 4 are guided by means of guide rails 7a or 7b and 7c extending over the height of the shaft.

The elevator cage 2 can at a conveying height h serve an uppermost story with a story door 8, further stories with story doors 9 and 10 and a lowermost story with story door 11. The elevator shaft 1 is formed by lateral shaft walls 15a and 15b, a rear shaft wall 15c, a shaft ceiling 13 and a shaft floor 14, on which a shaft floor buffer 19a for the counterweight 4 and two shaft floor buffers 19b and 19c for the elevator cage 2 are arranged.

The supporting and drive means 3 is fastened to the shaft ceiling 13 at a stationary fastening point or support means fixing point 16a and is led parallel to the lateral shaft wall 15a to a support roller 17 for the counterweight 4. From here, it goes back again over the drive pulley 5, continues to a first deflecting or support roller 18a and a second deflecting or support roller 18b, loops under the elevator cage 2, and continues to a second stationary fastening point or support means fixing point 16b at the shaft ceiling 13.

Moreover, FIG. 1 shows symbolically and by way of example a fastening device 200 for the guide rails 7b and 7c, with in each instance a floor mount 20a or 20a′ and respective mounts 21a-21e or 21a′-21e′ by which the guide rails 7b and 7c are fastened to the rear shaft wall 15c.

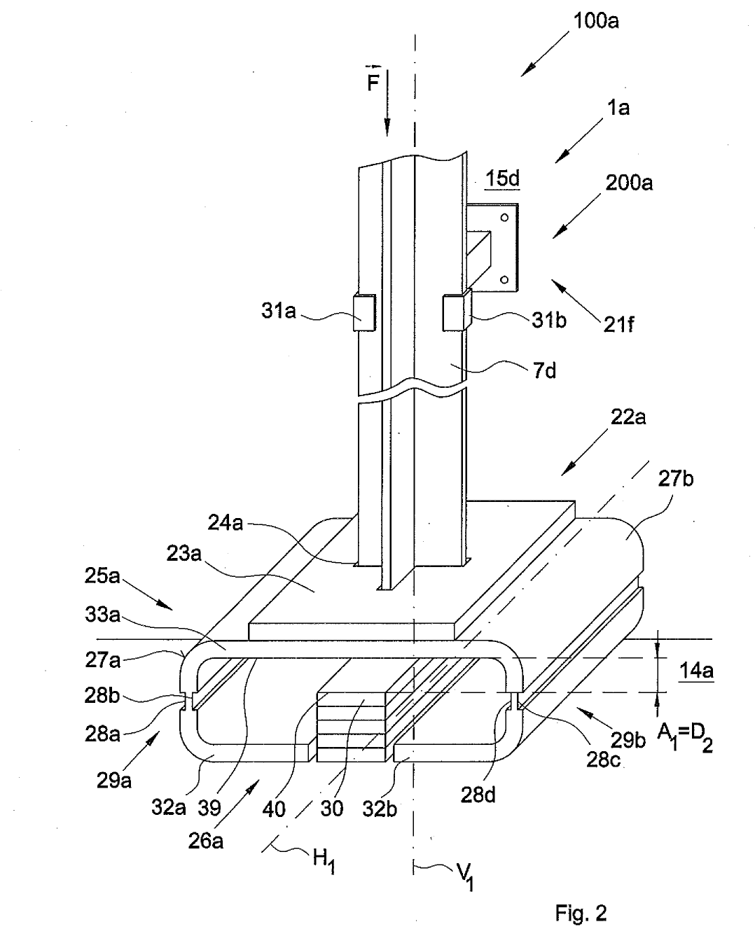

FIG. 2 schematically shows a fastening device 200a, which is a component of an elevator installation 100a. A support device 22a stands, at an underside 26a or two base surfaces 32a and 32b, on a shaft floor 14a of an elevator shaft 1a. The two base surfaces 32a and 32b respectively go over into side flanks 27a and 27b, which each have an outwardly disposed groove 28a or 28c as well as an inwardly disposed groove 28b or 28d. The grooves 28a and 28b form an intended deformation point 29a in the side flank 27a and the grooves 28c and 28d form an intended deformation point 29b in the side flank 27b.

The side flanks 27a and 27b of the support device 22a go over into a common cap surface 33a, on the upper side 25a of which a support plate 23a is arranged to be approximately parallel to a horizontal H₁. The support plate 23a has a seat 24a which corresponds with the cross-sectional profile of a guide rail 7d. The seat 24a has a smaller depth than the thickness of the support plate 23a and gives lateral retention to the guide rail 7d. The same retention can optionally also be achieved by an elevated profile which is, for example, welded on.

The guide rail 7d therefore stands approximately vertically, thus parallel to a vertical V₁, on the support plate 23a. Vertical forces F which arise in the guide rail 7d thus press on the support plate 23a, on the cover surface 33a and, by way of the side flanks 27a and 27b, on the intended deformation points 29a and 29b. The material characteristics and the thickness of the target deformation points 29a and 29b are so designed that an absolute amount of the vertical force F, which corresponds with a normal loading in the guide rail 7d, still does not cause a plastic deformation, neither in the target deformation points 29a and 29b nor in the support plate 23a, the cover surface 33a and/or the side flanks 27a and 27b.

If, however, the vertical loading by the vertical force F in the guide rail 7d should attain a peak load exceeding the normal amount, the intended deformation points 29a and 29b deform until, at the most, a lower side 39 of the cover surface 33a rests on an upper side 40 of a support piece 30. The support piece 30 is the uppermost support piece of a support piece packet, which depending on the respective need is adaptable in its overall height by withdrawal or insertion of support pieces. In the illustrated undeformed state of the support device 22a a spacing A₁ corresponding with a maximum possible deformation D₂ is present between the lower side 39 of the cap surface 33a and the upper side 40 of the uppermost support piece 30.

Further components of the fastening device 200a are mounts, of which only one mount 21f is illustrated by way of example. By means of retaining guides 31a and 31b which engage around the profile of the guide rail 7d the guide rail 7d is fastened to a shaft wall 15d of the elevator shaft 1a and, in particular, so that the guide rail 7d is kept in the horizontal H₁, but remains displaceable in the vertical V₁ under the action of an appropriately high vertical force F.

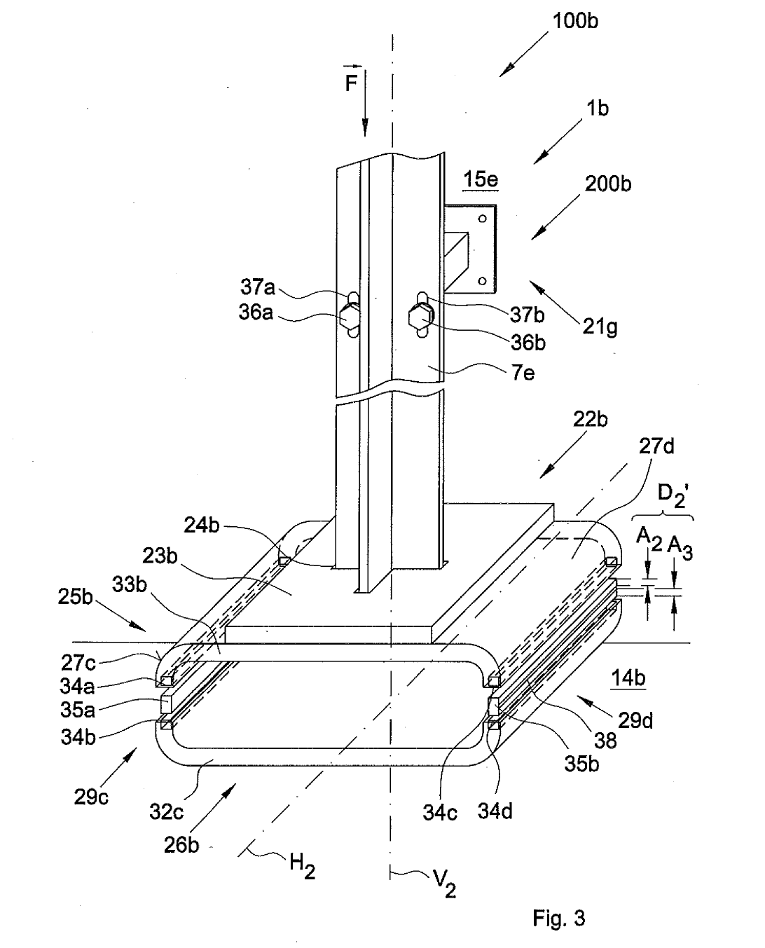

A further variant of embodiment of a fastening device 200b for a guide rail 7e is schematically illustrated in FIG. 3. Arranged on a shaft base 14b, which lies in a horizontal H₂, is a support device 22b which is shown schematically in an exploded illustration and which is formed substantially by a continuous base surface 32c with a lower side 26b and a cap surface 33b with an upper side 25b. By contrast with the variant of embodiment of a support device 200a of FIG. 2, side flanks 27c and 27d are separated and form intended deformation points 29c and 29d in that a respective deformable bar 35a or 35b is insertable into housing parts 34a and 34b at the side of the side flank 27c and into further housing parts 34c and 34d at the side of the side flank 27d.

Two spacings A₂ and A₃—in effect the compressibility of the deformable bars 35a and 35b—give in total a maximum deformation D₂′ of the support device 22b. In addition, a colored marking 38 is illustrated at the side of the deformable bar 35b. in the uncompressed state of the deformable bar 35b the surfaces above and below the colored marking 38 at the edges of the housing parts 34c and 34d are still visible, but when the deformable bar 35b has been compressed only the colored marking 38 exclusively can still be seen in a residual gap between the edges of the housing parts 343c and 34d. In this manner it is ascertainable by means of a visual check whether the guide rail 7e has settled. By finely stepped differently colored markings it would be possible to ascertain the degree of deformation attained by the deformable bar 35b. As an alternative to the just-described visual check it is possible to insert one or more pressure sensors into the deformable bars 35a and 35b or also into only one of the two deformable bars 35a and 35b.

A support plate 23b is arranged on the upper side 25b of the cap surface 33b in a horizontal H₂, as also shown in the preceding FIG. 2. The guide rail 7e stands approximately vertically, thus parallel to a vertical V₂, in a seat 24b. The guide rail 7e is fastened to a shaft wall 15e by means of mounts, of which one mount 21g is illustrated by way of example. The mount 21g has screw connections 36a and 36b which so retain the guide rail 7e in slots 37a and 37b that it is fixed in the horizontal H₂, but which in the vertical V₂ can describe a displacement movement along the vertical V₂ under the action of an appropriately high vertical force F.

With the same fastening preconditions, corresponding mounts 21g are also conceivable which retain not only a guide rail 7e in the form of a T-profile, but also guide rails in the form of a cruciform profile.

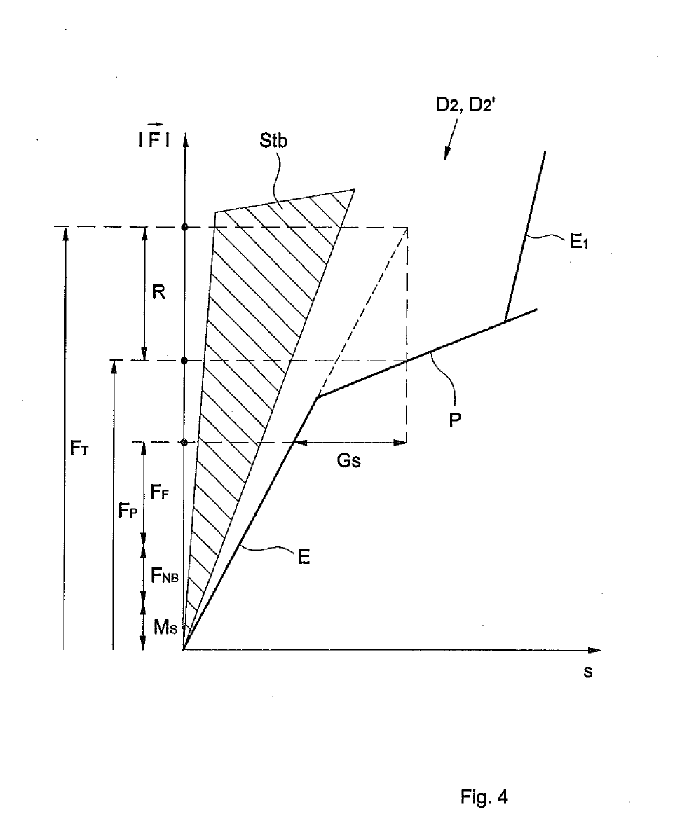

FIG. 4 shows an exemplary plot of a maximum possible deformation D₂ or D₂′ of the support device 22a of FIG. 2 or the support device 22b of FIG. 3, in dependence on an absolute amount of the vertical force |F| on the Y axis and a travel s on the X axis.

The deformation D₂ or D₂′ consists of an elastic range E, a plastic range P and an elastic range E₁ on contact with the support pieces. Gs represents the travel of the building under settling. The mass of the guide rail is illustrated at the ordinate by M_{S}, the operational forces in normal operation by F_{NB}, the operational forces in the case of safety braking of the elevator cage by F_{F}, the vertical force with plasticization by F_{P}, the theoretical vertical force without plasticization by F_{T} and the reduction due to plasticization by R. The area Stb represents the likely range of stiffness of a guide rail.

The following is a reference numeral list for the accompanying figures:

1, 1a, 1b elevator shaft

2 elevator cage

3 supporting and drive means

4 counterweight

5 drive pulley

6 drive unit

7a-7e guide rail

8 uppermost story door, uppermost shaft door

9, 9a, 9b story door, shaft door

10, 10a, 10b story door, shaft door

11 lowermost story door, lowermost shaft door

12 engine room

13 shaft ceiling

14, 14a, 14b shaft floor

15a-15e shaft wall

16a, 16b stationary fastening point, support means fixing point

17 support roller for 4

18a-18b deflecting roller, support roller for 2

19a-19c shaft floor buffer

20a, 20a′ floor mount for 7

21a-21e, 21a′-21e′;

21f, 21g mount for 7

22a, 22b support device

23a, 23b support plate

24a, 24b seat

25a, 25b upper side of 33

26a, 26b lower side

27a-27d side flank

28a-28d groove

29a-29d intended deformation point

30 support piece

31a, 31b retaining guide

32a-32c base surface

33a, 33b cap surface

34a-34d housing parts

35a, 35b deformable bar

36a, 36b screw connection

37a, 37b slot

38 colored marking

39 lower side of 33

40 upper side of 30

100, 100a, 100b elevator installation

200, 200a, 200b fastening device

A₁-A₃ spacing

D₁, D₂, D₂′ deformation

E, E₁ elastic range

|F| absolute amount of the vertical force F in 7

F_{F} operational forces in the case of safety braking

F_{NB} operational forces in the case of normal operation

F_{P} vertical force with plastification

F_{T} theoretical vertical force without plastification

Gs travel of the building settling

H₁, H₂ horizontal

M_{S} mass of 7

P plastic range

R reduction due to the plastification

s travel

Stb apparent range of stiffness of 7 without 22

V₁, V₂ vertical

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. An elevator guide rail fastening device comprising at least one plastically deformable support device for an elevator guide rail, wherein the support device has a predetermined deformation characteristic.

2. The elevator guide rail fastening device of claim 1, the support device comprising at least a first side flank and a second side flank, the first and second side flanks each comprising at least one respective deformation point.

3. The elevator guide rail fastening device of claim 2, wherein the at least one respective deformation points each comprise at least one respective groove.

4. The elevator guide rail fastening device of claim 2, wherein the at least one respective deformation points each comprise one or more respective deformable bars.

5. The elevator guide rail fastening device of claim 4, wherein the one or more respective deformable bars comprise visible deformation markings.

6. The elevator guide rail fastening device of claim 4, wherein the one or more respective deformable bars comprise at least one pressure sensor.

7. The elevator guide rail fastening device of claim 1, further comprising at least one support piece configured to limit deformation of the support device.

8. The elevator guide rail fastening device of claim 7, the at least one support piece comprising at least one pressure sensor.

9. The elevator guide rail fastening device of claim 1, further comprising at least one mount, the at least one mount being configured to hold the guide rail in a vertically displaceable manner.

10. The elevator guide rail fastening device of claim 9, wherein at least one end of the guide rail is arranged in a seat of a support plate.

11. The elevator guide rail fastening device of claim 9, wherein the at least one mount comprises at least one retaining guide configured to couple to at least a portion of the guide rail.

12. The elevator guide rail fastening device of claim 9, wherein the at least one mount comprises connecting holes configured to receive connectors coupled to the guide rail.

13. The elevator guide rail fastening device of claim 1, wherein the at least one plastically deformable support device has a C-shaped cross-section.

14. An elevator installation comprising:
at least one elevator car disposed in an elevator shaft;
at least one elevator guide rail running along a portion of a vertical axis of the elevator shaft; and
at least one elevator guide rail fastening device coupled to the at least one elevator guide rail, the at least one elevator guide rail fastening device comprising at least one deformable support configured to receive an end of the at least one elevator guide rail.

15. The elevator installation of claim 14, wherein the at least one deformable support comprises at least one pressure sensor.

16. The elevator installation of claim 14, wherein the at least one deformable support comprises a visible indicator of deformation of the at least one deformable support.

17. The elevator installation of claim 14, wherein the at least one deformable support comprises a deformation point means.

18. An elevator system method, comprising:
supporting an end of an elevator guide rail on a plastically deformable support device, the elevator guide rail being disposed in an elevator shaft; and
at least partially deforming the plastically deformable support device by exerting a force on the elevator guide rail.

19. The elevator system method of claim 18, further comprising removing at least one support piece from the at least partially deformed support device to allow for further deformation.
